(19) United States
(12) Patent Application Publication
(10) Pub. No.: US 2025/0242485 A1
(43) Pub. Date: Jul. 31, 2025

(54) VARIABLE STIFFNESS ACTUATOR

(71) Applicants: Hyunglae Lee, Phoenix, AZ (US); Matthew Auer, Hawthorne, CA (US); Suhrud Parag Joglekar, Tempe, AZ (US)

(72) Inventors: Hyunglae Lee, Phoenix, AZ (US); Matthew Auer, Hawthorne, CA (US); Suhrud Parag Joglekar, Tempe, AZ (US)

(21) Appl. No.: 19/035,378

(22) Filed: Jan. 23, 2025

Related U.S. Application Data
(60) Provisional application No. 63/625,533, filed on Jan. 26, 2024.

(51) Int. Cl. B25J 9/00; A61H 3/00

(52) U.S. Cl. CPC B25J 9/0006; A61H 3/00

(57) ABSTRACT

A variable stiffness actuator including a main cam, connecting pin, spiral cam, housing, a cantilever subassembly, and a spiral cam pin. The main cam has a main cam surface and is configured for rotation about a rotary axis. The connecting pin is coupled to the main cam. The spiral cam defines a spiral cam slot. The main cam is positioned within the housing and the housing includes a housing connector. The cantilever subassembly includes a cantilever beam, a first support coupled to the housing, a roller in contact with the main cam surface, and a second support spaced a distance from the first support. The spiral cam pin is positioned within the spiral cam slot for movement upon rotation of the spiral cam. The spiral cam is rotatable between a first setting and second setting to adjust the distance and a corresponding stiffness profile of the actuator.

### RELATED APPLICATIONS

This application claims the benefit of U.S. Provisional Patent Application No. 63/625,533, filed Jan. 26, 2024, entitled “VARIABLE STIFFNESS ACTUATOR”, the entire content of which is incorporated herein by reference.

### STATEMENT REGARDING FEDERALLY SPONSORED RESEARCH OR DEVELOPMENT

This invention was made with government support under R01 AR080826 awarded by the National Institutes of Health. The government has certain rights in the invention.

### FIELD

The present disclosure generally relates to actuators.

### BACKGROUND

Robotics are commonly used in mobility assistance prosthetic devices such as powered exoskeletons. Some prosthetic or orthotic devices assist with ankle flexion and extension. Known powered exoskeletons include actuators with motors and transmissions which require power and intricate control. Variable Stiffness Actuators (VSAs) are mechanisms designed with elastic elements that allow for adjustment of the stiffness based on the specific task or environment. Some VSAs can adjust elastic element response to the environment-especially during energy storage and release.

Typically, ankle muscles are capable of dorsiflexion (i.e., movement of the foot upwards so that the foot is closer to the shin) and plantarflexion (i.e., extension of the foot downwards so that the foot is farther from the shin) from a stationary position in which the foot points forward of the shin. Joint power provided by ankle muscles varies as a function of gait phase. A typical gait phase (i.e., walking cycle) includes a stance phase (e.g., where the foot is in contact with the ground) and a swing phase (e.g., where the foot is not in contact with the ground). Ankle angle relative to the stationary position increases during the stance phase and the energy is released during toe-off at around 50% gait phase. Then after 50% gait phase, the ankle angle in the plantarflexion direction is large, and the joint power is zero because the joint is unloaded.

Elderly people may experience deteriorating ankle muscles and may require gait assistance. People with gait disorders may require gait assistance. Gait assistance may also be required during rehabilitation of typical ankles after injury.

### SUMMARY

The disclosure provides, in one aspect, a variable stiffness actuator assembly configured for use in a prosthetic device, the variable stiffness actuator assembly including a main cam, a connecting pin, a spiral cam, a housing, a cantilever subassembly, and a spiral cam pin. The main cam includes a main cam surface, and is configured for rotation about a rotary axis. The connecting pin is coupled to the main cam for movement therewith and is configured to be coupled to a first element of the prosthetic device. The spiral cam defines a spiral cam slot. The main cam is positioned within the housing. The housing includes a housing connector configured to be coupled to a second element of the prosthetic device. The cantilever subassembly includes a cantilever beam, a first support, a roller, and a second support. The cantilever beam has a first end and an opposite second end. The first support is adjacent the first end of the cantilever beam and is coupled to the housing. The roller is adjacent the second end of the cantilever beam. The roller is in contact with the main cam surface such that the cantilever beam opposes rotation of the main cam. The second support is spaced a distance from the first support. The spiral cam is positioned at least partially within the spiral cam slot for movement along the spiral cam slot upon rotation of the spiral cam. The spiral cam pin is coupled to the second support such that rotation of the spiral cam causes movement of the second support. The spiral cam is rotatable about the rotary axis between a first setting and a second setting such that the spiral cam is configured to adjust the distance. In the first setting, the second support is a first distance from the first support, and the variable stiffness actuator assembly exhibits a first stiffness profile. In the second setting, the second support is a second distance from the first support, the second distance being different from the first distance, and the variable stiffness actuator assembly exhibits a second stiffness profile different from the first stiffness profile.

The disclosure provides, in another independent aspect, a variable stiffness actuator including a main cam and a cantilever subassembly. The main cam includes a main cam surface and is configured for rotation about a rotary axis. The cantilever subassembly includes a cantilever beam and a roller at a free end thereof, the roller being in contact with the main cam such that the cantilever subassembly opposes rotation of the main cam. The main cam surface and the roller together define a cam follower trajectory curve which includes at least a first segment and a second segment separated by a theoretical equilibrium, the first segment and the second segment being different in curvature. When the roller contacts the main cam surface at a first position corresponding with the first segment, the cantilever beam functions with a first stiffness. When the roller contacts the main cam surface at a position corresponding with the second segment, the cantilever beam functions with a second stiffness different than the first stiffness.

The disclosure provides, in another independent aspect, a variable stiffness actuator including a main cam, a cantilever subassembly, and a spiral cam. The main cam includes a main cam surface and is configured for rotation about a rotary axis. The cantilever subassembly includes a support. The spiral cam includes a spiral cam slot curved about the rotary axis in a spiral cam trajectory and a spiral cam pin positioned at least partially within the spiral cam slot for movement along the spiral cam slot upon rotation of the spiral cam. The spiral cam pin is coupled to the support such that rotation of the spiral cam causes translation of the support along a cantilever axis transverse to the rotary axis. The spiral cam trajectory is curved such that a pressure angle between the cantilever axis and a tangent line extending through the spiral cam slot at a contact point between the spiral cam pin and the spiral cam slot is maintained throughout a range of motion of the spiral cam pin in the spiral cam slot.

Other aspects of the disclosure will become apparent by consideration of the detailed description and accompanying drawings.

### BRIEF DESCRIPTION OF THE DRAWINGS

FIG. 1 illustrates a first perspective view of a variable stiffness actuator.

FIG. 2 illustrates a second perspective view of the actuator of FIG. 1.

FIG. 3A illustrates an end view of the actuator of FIG. 1 with a spiral cam thereof in a first position.

FIG. 3B illustrates an end view of the actuator of FIG. 1 with the spiral cam thereof in a second position.

FIG. 4 is an end view of the actuator with a portion of the housing removed.

FIG. 5A is an end view of the actuator of FIG. 1 with the portion of the housing and the spiral cam removed.

FIG. 5B is an end view of the actuator of FIG. 1 with the portion of the housing and the spiral cam removed and illustrating, in dashed lines, alternate positions of cantilever supports.

FIG. 6A illustrates a cantilever beam structure including a pinned end with a moving rolling support.

FIG. 6B illustrates a cantilever beam structure including a fixed end with a moving rolling support.

FIG. 6C illustrates a cantilever beam structure including a pinned end with a movable fixed support.

FIG. 7A illustrates a cantilever beam structure with a semi-fixed end support with a moving flexible roller support.

FIG. 7B illustrates a free body diagram of the cantilever beam structure of FIG. 7A.

FIG. 7C illustrates an end view of the cantilever beam of FIG. 7A.

FIG. 8 illustrates the main cam and portions of three cantilever subassemblies as presented in the actuator of FIG. 1.

FIG. 9 is a perspective view of the main cam of FIG. 8.

FIG. 10 illustrates a main cam follower trajectory curve schematic of the actuator of FIG. 1.

FIG. 11 is an end view of the spiral cam of the actuator of FIG. 1.

FIG. 12A is an experimentally gathered torque-deflection plot the actuator of FIG. 1.

FIG. 12B is an analytical torque-deflection plot of the actuator of FIG. 1.

FIG. 13 is a chart illustrating exemplary actual and analytical stiffness of the actuator for various spiral cam settings.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

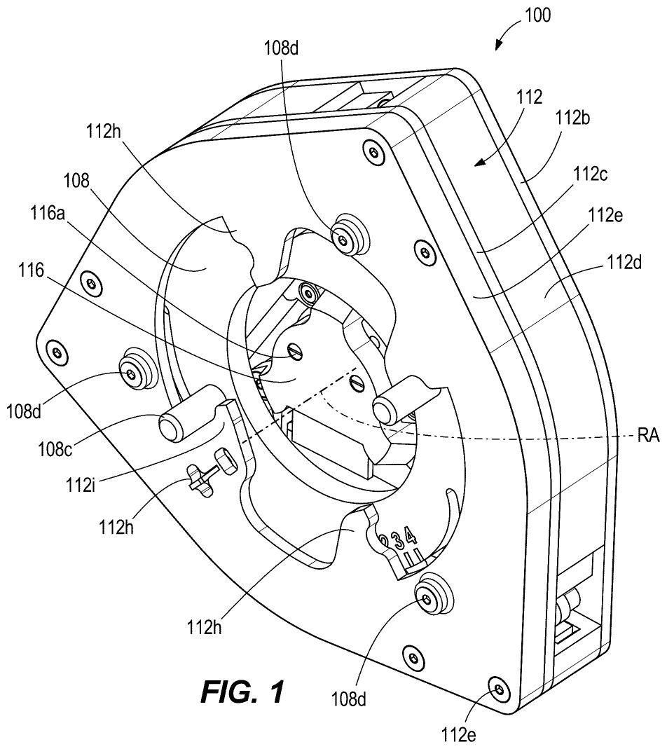

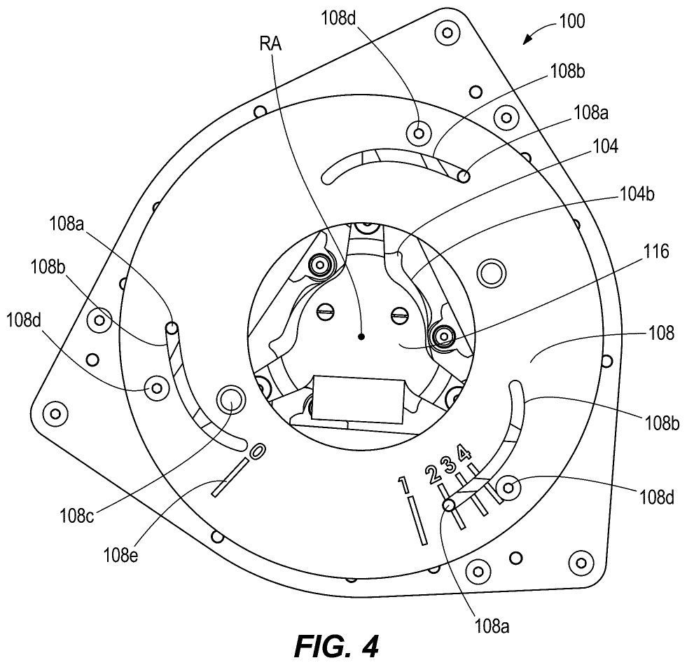

FIGS. 1-5B illustrate an actuator 100 configured to be adjusted to different settings corresponding with various stiffness profiles and to provide relatively high stiffness during a stance gait phase (i.e., dorsiflexion, rotation in a first direction), and with relatively low stiffness to minimally impede movement thereof during a swing gait phase (i.e., plantarflexion, rotation in an opposite second direction). Due to variable stiffness of the actuator 100 during a single gait cycle while in a single setting, and the capability of the actuator 100 to be adjusted to different stiffness profiles, the actuator 100 is considered a variable stiffness actuator. Due to the geometries of the actuator 100 as described below, the actuator 100 is also considered a spiral cam actuator. The actuator 100 includes a main cam 104 coupled to at least one connecting pin 104a, a spiral cam 108 coupled to a plurality of spiral cam pins 108a, a housing 112 including a housing connector 112a, and a cantilever subassembly 200. The main cam 104 and the cantilever subassembly 200 are configured to convert linear stiffness of the cantilever subassembly 200 to rotational stiffness.

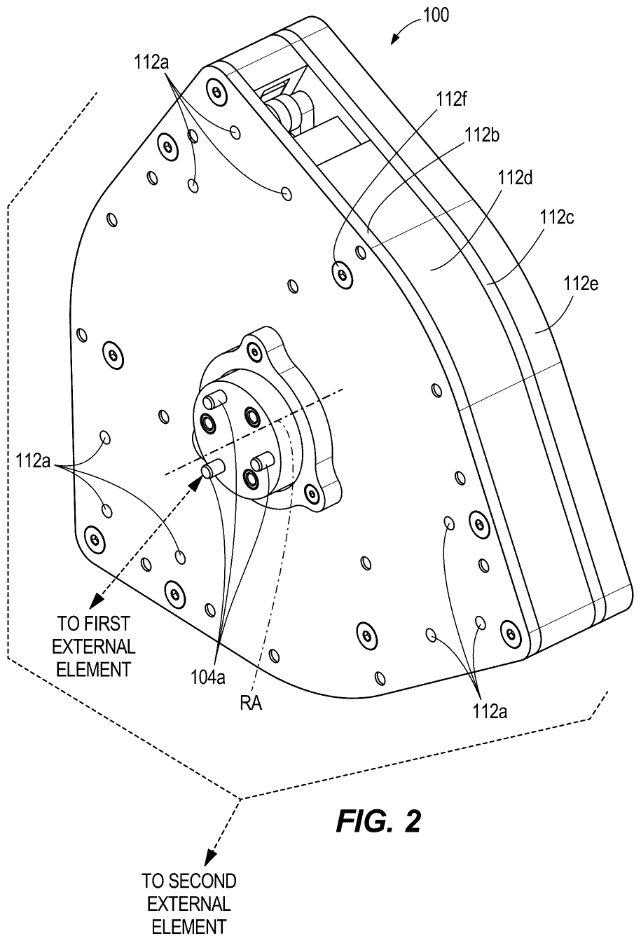

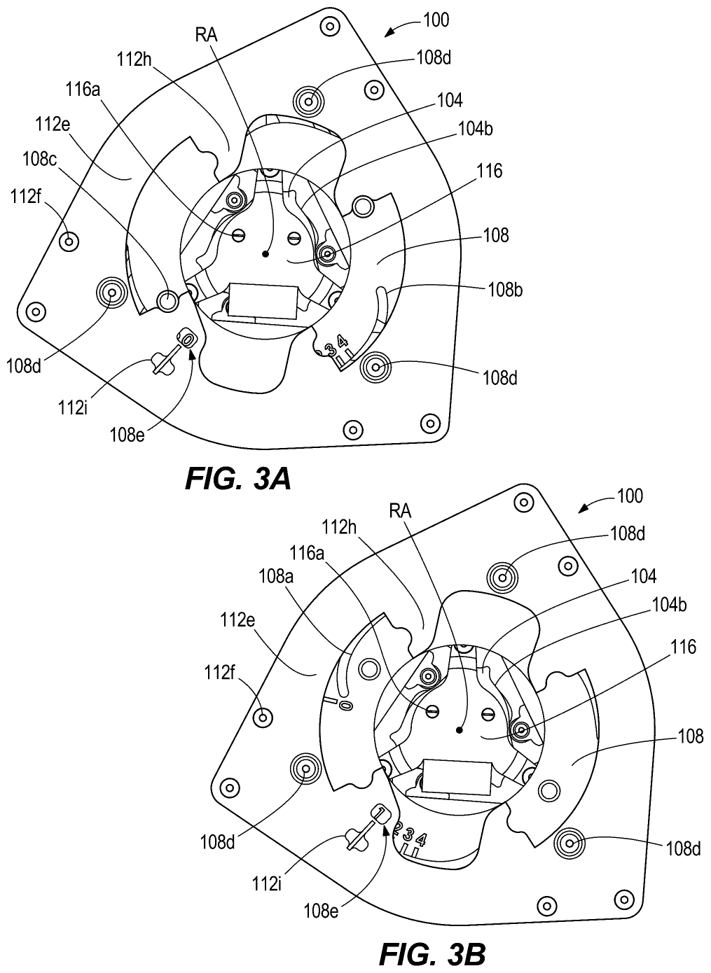

The actuator 100 is configured to be coupled to an external device such as a prosthetic device by the main cam 104 and the housing 112. While described here as being capable of connected to a prosthetic device, the actuator 100 is capable of use in other mechanisms. FIGS. 3A-3B illustrate the main cam 104. In the illustrated embodiment, the main cam 104 is positioned within the housing 112, and is coupled to the housing 112 for rotational movement about a rotary axis RA. FIG. 2 illustrates the connecting pin 104a of the main cam 104. The connecting pin 104a is coupled to the main cam 104 for co-rotation therewith about the rotary axis RA. In the illustrated embodiment, three connecting pins 104a are connected to the main cam 104. Other examples include other numbers of pins 104a.

FIG. 2 further illustrates the housing connector 112a. In the illustrated embodiment, the housing connector 112a is formed as a series of holes in a rear block 112b of the housing 112. The illustrated housing 112 includes the rear block 112b, a front block 112c opposite the rear block 112b, and a central block 112d sandwiched between the rear block 112b and the front block 112c. In the illustrated embodiment, the rear block 112b, front block 112c, and central block 112d are stacked along the rotary axis RA. A front plate 112e is coupled to the front block 112c forward of the front block 112c. A plurality of housing fasteners 112f secure the blocks 112b-112d and the front plate 112e to one another. In the illustrated embodiment, both the connecting pins 104a and the housing connectors 112a extend in a direction parallel with the rotary axis RA. Other arrangements may differ.

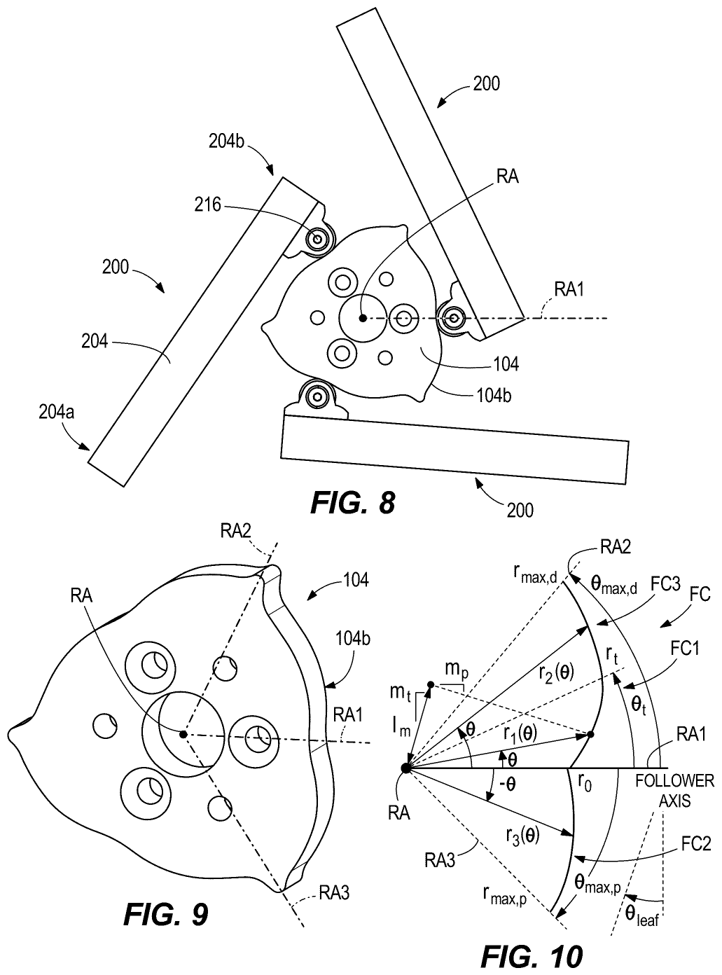

FIGS. 3A-3B, 5A-5B, 8 and 9 further illustrate the main cam 104. The main cam 104 includes a main cam surface 104b configured to interact with the cantilever subassembly 200 to convert linear stiffness of the cantilever subassembly 200 to rotary stiffness. In the illustrated embodiment, the main cam surface 104b is an outer most radial surface of the main cam 104. In other words, the main cam surface 104b is furthest from and faces away from the rotary axis RA. Other arrangements may differ.

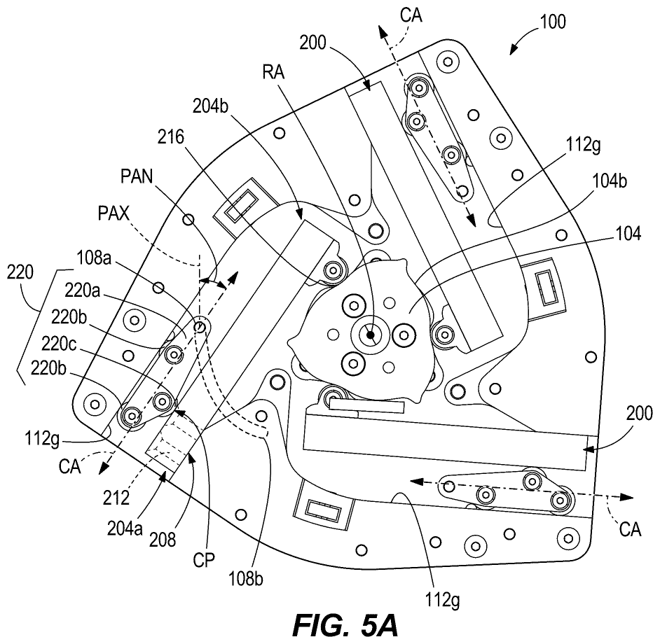

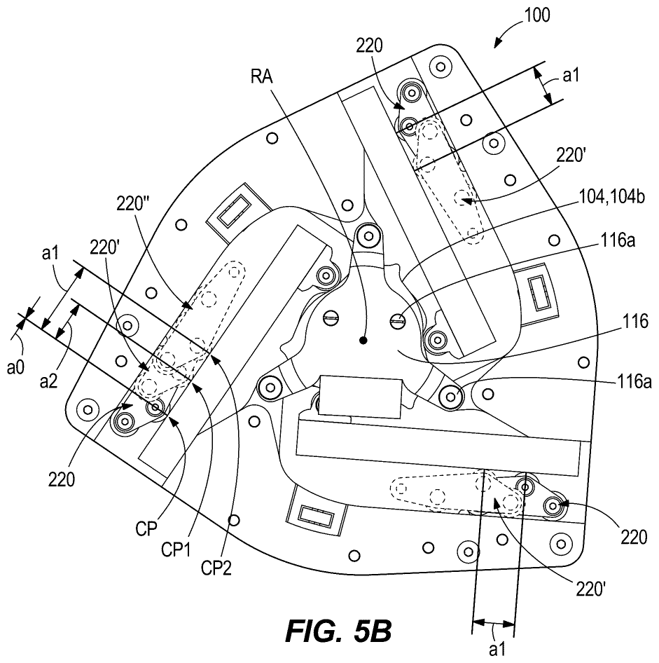

At least FIGS. 1, 3A, and 5B illustrate an instrumentation plate 116 which is selectively coupled to the housing 112 and configured to mount instrumentation (e.g., a rotary magnetic angle encoder) capable of monitoring a position of the main cam 104 relative to the housing 112. The instrumentation plate 116 is secured to the housing 112 by fasteners 116a. The fasteners 116a are removable to provide access for a user to remove the main cam 104 and the replace the main cam 104 with a second main cam 104 having a different curvature in comparison with the main cam surface 104b of the original (i.e., first) main cam 104. FIG. 5A illustrates the actuator 100 with the instrumentation plate 116 removed.

FIGS. 5A-5B illustrate the cantilever subassembly 200 in detail. The cantilever subassembly 200 includes a cantilever beam 204 having a first end 204a and an opposite second end 204b (i.e., a free end). The cantilever beam 204 includes a first support 208 adjacent the first end 204a thereof. The first support 208 is coupled to the housing 112. More specifically, the first support 208 is coupled within a cantilever receptacle 112g of the central block 112d of the housing 112 by a fastener 212. In the illustrated embodiment, a plurality of fasteners 212 secure the first support 208 to the central block 112d. The cantilever subassembly 200 further includes a beam roller 216 adjacent the second end 204b of the cantilever beam 204. The beam roller 216 is configured to contact the main cam surface 104b such that the cantilever beam 204 opposes rotation of the main cam 104. The cantilever subassembly 200 further includes a second support 220 spaced a distance a0, a1, a2 from the first support 208. Depending on the setting of the actuator 100, the distance a0, a1, a2 may be nominally zero or nominally nonzero. Movement of the spiral cam 108 and the continuous shape of the spiral cam slot 108b permit infinite adjustment of the distance a0, a1, a2 bounded by, for example, movement of the second support 220 within the cantilever receptacle 112g or the circumferential length of the spiral cam slot 108b itself. As illustrated, distance a0 represents a nominally zero distance between the first support 208 and the second support 220. Upon movement of the spiral cam 108, any non-zero distance including the distances a1, a2 as well as an infinite number of additional non-zero distances between the distance a0 and distance a1, between the distance a1 and the distance a2, and between distance a2 and an inner surface of the cantilever receptacle 112g transverse to the cantilever axis CA.

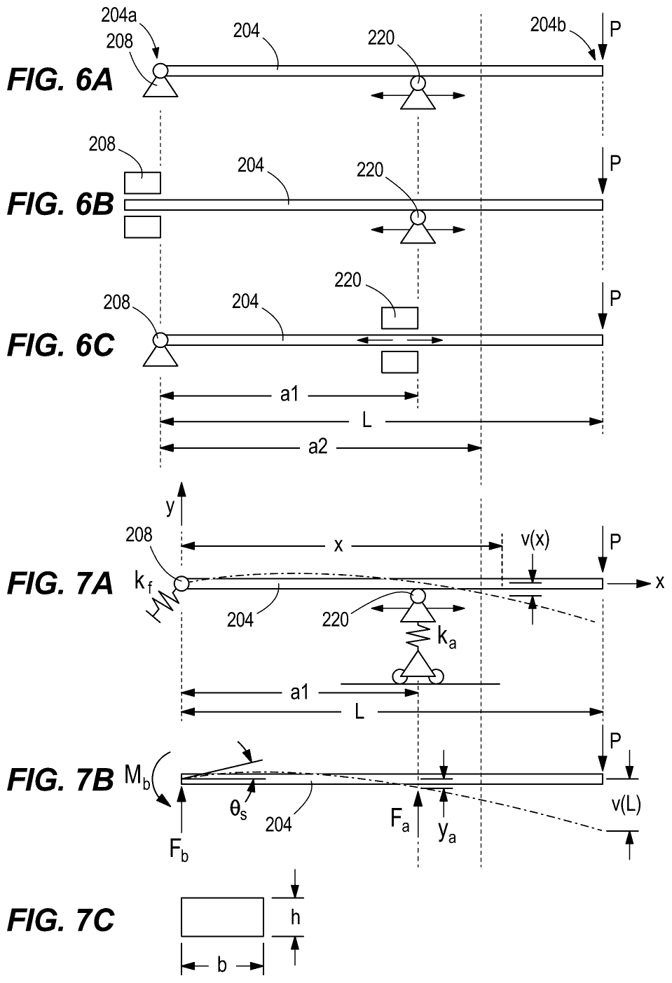

FIGS. 6A-6C are schematic illustrations of different types of cantilever subassemblies 200 having different first supports 208 and second supports 220. Any of these types of cantilever subassemblies 200 or any other type of cantilever subassembly 200 may be used in the actuator 100. FIG. 6A illustrates an assembly 200 having a pinned first support 208 and a roller second support 220. FIG. 6B illustrates an assembly 200 having a fixed first support 208 and a roller second support 220. FIG. 6C illustrates an assembly 200 having a pinned first support 208 and a fixed second support 220. As will be described with regard to the spiral cam 108, the distance a0, a1, a2 between the first support 208 and the second support 220 is capable of being adjusted. In other words, the roller second supports 220 of the FIGS. 6A and 6B embodiments, and the fixed second supports 220 of the FIG. 6C embodiment is movable relative to the first support 208. Other arrangements are possible. The length L spans the first end 204a and the second end 204b (i.e., distal end) of the cantilever beam 204. The second end 204b of the cantilever beam 204 contacts the main cam 104 for transmitting force P between the cantilever subassembly 200 and the main cam 104.

FIG. 7A illustrates another model cantilever subassembly 200 with a semi-fixed first support 208 fixed by a spring kf to the housing 112. The second support 220 of the FIG. 7A embodiment includes a moving flexible roller support ka. The moving flexible roller support ka is movable between a first distance al and a second distance a2 relative to the first support 208.

FIG. 7B is a free body diagram of the FIG. 7A model cantilever subassembly 200. Upon receipt of force P, a bending moment Mb and a first support force Fb are present at the first support 208, and a second support force Fa is present at the second support 220. As illustrated by angle Θs, the cantilever beam 204 is capable of angular displacement at the first end 204a of the cantilever. As illustrated by length ya, the moving flexible roller support ka allows the second support 220 to be capable of linear displacement. In the illustrated embodiment, the flexible roller support ka is oriented generally perpendicular to the cantilever beam 204 and the second support 220 is capable of linear displacement in a direction generally perpendicular to the cantilever beam 204.

FIG. 7C illustrates an end view of the cantilever beam 204. In the illustrated embodiment, the cantilever beam 204 has a rectangular shape having a constant width b and a constant height h. The cantilever beam 204 may be dimensioned as any other viable cross-sectional shape (e.g., square, circle, any polygonal shape, etc.).

FIGS. 5A, 5B illustrate the physical cantilever subassembly 200 which is illustrated schematically in FIGS. 6A-7C. The second support 220 includes a body 220a, two housing rollers 220b in contact with the cantilever receptacle 112g, and one contact roller 220c on an opposite side of the body 220a compared to the housing rollers 220b. The contact roller 220c is in contact with the cantilever beam 204 at a contact point CP. The spiral cam pin 108a is coupled to the body 220a of the second support 220. The contact roller 220 is movable along a cantilever axis CA. In the illustrated embodiment, the contact roller 220 is linearly translatable along the cantilever axis CA. The cantilever axis CA extends in a direction transverse to the rotary axis. As illustrated in FIGS. 5A and 5B, the cantilever axis CA does not intersect the rotary axis RA and is spaced radially from the rotary axis RA (which extends into and out of the page as viewed in FIGS. 5A and 5B).

The illustrated actuator 100 (FIG. 5A) includes three sets of cantilever receptacles 112g and cantilever subassemblies 200. The illustrated cantilever receptacles 112g and cantilever subassemblies 200 are arranged with equal circumferential spacing about the rotary axis RA. Other embodiments may include more or fewer sets of cantilever receptacles 112g and cantilever subassemblies 200 having equal or unequal circumferential spacing about the rotary axis RA.

With reference to FIGS. 5A and 8-10, the main cam surface 104b is dimensioned such that the main cam surface 104b and the roller 216 together define a cam follower trajectory curve FC (FIG. 10). The cam follower trajectory curve FC includes a first segment FC1, a second segment FC2, and a third segment FC3. The first segment FC1 and second segment FC2 are separated by a theoretical equilibrium reference axis RA1 that intersects and extends radially outwardly from the rotary axis RA.

The first segment FC1 and the second segment FC2 are different in their curvature about the rotary axis RA. In the illustrated embodiment, the first segment FC1, second segment FC2, and FC3 are each different in their curvature about the rotary axis RA. From the reference axis RAI to angle Θt, a radius r1(Θ)) of the first segment FC1 increases based on a first equation, for example, from r0 to rt. In the same direction (i.e., +Θ), a radius r2(Θ) of the third segment increases based on a third equation different than the first equation, for example, from rt to rmax,d. In the opposite direction (i.e., −Θ) from the reference axis RA1 to angle Θmax,p, a radius r3(Θ)) of the second segment FC2 increases based on a second equation different than the first equation, for example, from r0 to rmax,p. Generally speaking, each of the first, second, and third equations serve to add a greater amount of additional length to the radius (r) as the angle (Θ) is rotated away from the reference axis RA1. In the illustrated embodiment, with further rotation away from the reference axis RA1, the amount of additional length to the radius (r) is decreased. However, in other embodiments, further rotational away from the reference axis RA1, the amount of additional length to the radius (r) may increase, and/or vary in any other manner (e.g., increasing and then decreasing, decreasing and then increasing, etc.) depending on the use case of the actuator 100.

The above-described curvature of the main cam surface 104b is designed for a particular use case in which the actuator 100 is designed for assisting human walking. Depending on the use case of the actuator 100, the main cam surface 104b can be dimensioned with differing dimensions to tailor the actuator 100 to the use case (e.g., a use case other than human walking). Various parameters of the main cam surface 104b can be altered. For example, a length of any of the radii r0, rmax,p, rmax,d, slopes at either side of the reference axes RA1, RA2, RA3, and/or other curvature of the first equation, second equation, and second equation, number of segments of the main cam surface 104b, etc. Other arrangements may differ.

The above-described cam follower trajectory curve FC ensures that a moment arm lm (FIG. 10) of the main cam 104 to be perpendicular to the cam follower trajectory curve FC, and extends through the rotary axis RA. In the illustrated embodiment, the cantilever subassemblies 200 are rotated (e.g., 7 degrees) to reset an equilibrium position of the actuator 100 at the follower axis. This rotation is illustrated by angle Θleaf. The lead line for angle Θleaf and moment arm lm are generally parallel to one another such that contact force on the main cam 104 is equal to the applied load received by the connecting pin 104a (e.g., via the external device, prosthetic device). In other words, the main cam 104 is statically biased such that a static equilibrium of the actuator 100 differs from a theoretical equilibrium presented by reference axis RA1. The other reference axes RA2, RA3 represent bounds of rotation of the main cam 104 relative to the reference axis RA1.

During operation of the actuator 100, a torque about the rotary axis RA is applied between the connecting pin 104a and the housing connector 112a (e.g., between the external elements connected to the connecting pin 104a and the housing connector 112a), and the roller 216 presses upon the main cam surface 104b along the cam follower trajectory curve FC. At least the cantilever beam 204 is loaded. During release of the applied torque, the energy stored in at least the cantilever beam 204 is unloaded to aid return of the connecting pin 104a and housing connector 112a toward their original unloaded (i.e., static) positions. In other words, the cantilever beam 204 is configured to be loaded and unloaded upon rotation of the main cam 104 to provide torque between the spiral cam pin 108a (e.g., and thus a first element of a prosthetic device) and the housing connector 112a (e.g., and thus the second element of the prosthetic device).

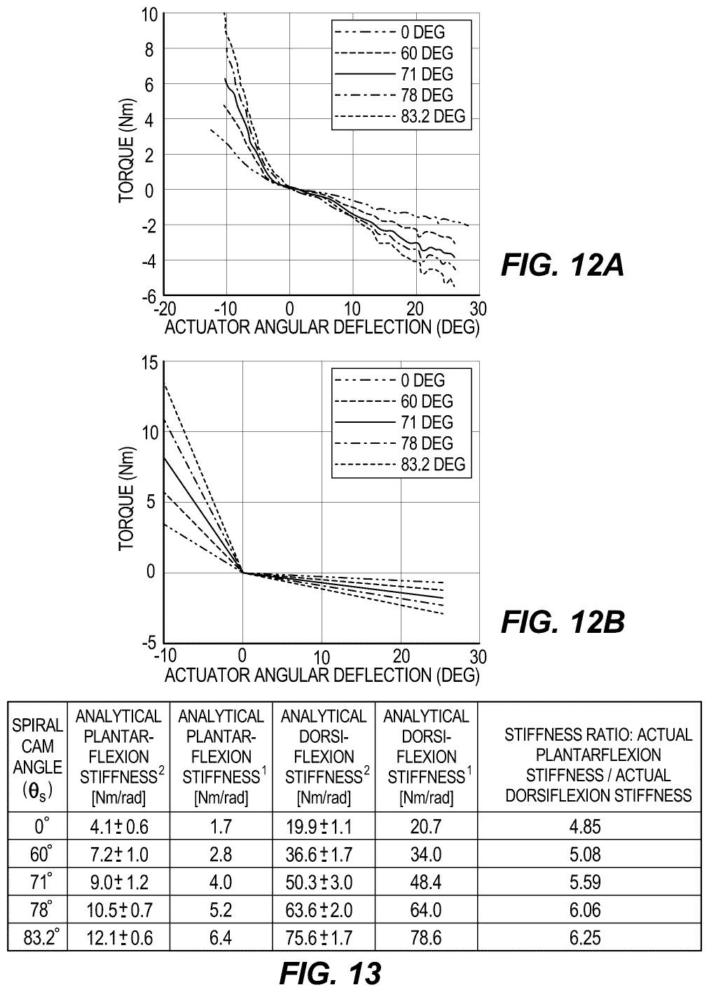

Due to geometry of the cam follower trajectory curve FC, when the roller 216 contacts the main cam surface 104b at a first position corresponding with the first segment FC1, the cantilever beam 204 functions with a first stiffness, and when the roller 216 contacts the main cam surface 104b at a second position corresponding with the second segment FC2, the cantilever beam 204 functions with a second stiffness different than the first stiffness. For example, as illustrated by FIGS. 12A-13, at a 0 degree spiral cam angle, the actuator 100 is configured to provide approximately 4.1 Newton-meters per radian (Nm/rad) of stiffness in a first rotation direction (i.e., plantarflexion), and approximately 19.9 Nm/rad of stiffness in an opposite second rotation direction (i.e., dorsiflexion). The actuator 100 can provide approximately 4.85 times the stiffness in plantarflexion direction in comparison to the dorsiflexion direction. In some embodiments, the stiffness of the actuator 100 in a first rotation direction (i.e., plantarflexion) may be at least 3.5 Nm/rad, whereas the stiffness of the actuator 100 in the second rotation direction (i.e., dorsiflexion) may be at least 18.8 Nm/rad. Other arrangements may differ in amount of stiffness provided in the first and second rotational directions.

At least FIGS. 1, 3A, 3B, 4, 5A-5B, and 11 illustrate operation of the spiral cam 108. The spiral cam 108 is operated to adjust an effective stiffness profile of the actuator 100 by simultaneously translating the second supports 220 of each of the three cantilever subassemblies 200. As mentioned above, the spiral cam pin 108a is coupled to the body 220a of the second support 220. The spiral cam 108 itself includes a spiral cam slot 108b. The illustrated spiral cam 108 includes three distinct spiral cam slots 108b which are curved about the rotary axis RA. Each illustrated spiral cam slot 108b is continuous in its curvature and devoid of distinct receptacles stemming therefrom for holding the spiral cam pin 108a. Each of the spiral cam slots 108b include the same curvature about the rotary axis RA. Rotation of the spiral cam 108 causes simultaneous movement (e.g., linear translation) of each of the second supports 220 of each of the three cantilever subassemblies 200. The spiral cam 108 is rotatable about the rotary axis RA to shift the actuator 100 between a plurality of settings where the second support 220 of the cantilever subassembly 200 is positioned at a different distance a0, a1, a2, etc. relative to the first support 208. Each setting corresponds with a different stiffness profile of the actuator 100.

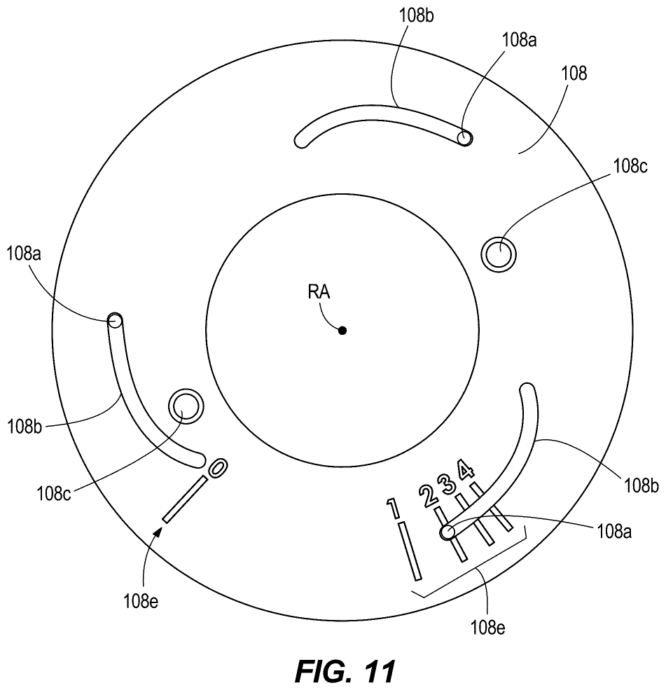

With reference to FIGS. 5A and 11, the spiral cam slots 108b are curved about the rotary axis RA along a spiral cam trajectory. A pressure axis PAX (FIG. 5A) extends tangent to the spiral cam slot 108b at a contact point between the spiral cam pin 108a, body 220a, and spiral cam slot 108b. In other words, the pressure axis PAX represents a tangent line extending through the spiral cam slot 108b at a contact point between the spiral cam pin 108a and the spiral cam slot 108b. A pressure angle PAN is measured the pressure axis PAX and the cantilever axis CA. Each of the spiral cam slots 108b extend along a spiral cam trajectory which follows a non-Archimedean spiral. In the illustrated embodiment, the spiral cam trajectory follows a third order polynomial equation. Coefficients of the third order polynomial equation are selected to maintain constant pressure angle PAN over a full range of motion of the spiral cam angle (i.e., rotation of the spiral cam 108 between settings). However, any other type of non-Archimedean spiral curve may be used so long as the pressure angle is maintained throughout a range of motion of the spiral cam pin 108a in the spiral cam slot 108b.

The spiral cam 108 is selectively coupled to the front plate 112e of the housing 112 by spiral cam clamps 108d (e.g., FIGS. 1, 3A, 3B). The spiral cam clamps 108d are configured to selectively lock the spiral cam 108 to the housing 112 in any one desired setting afforded by the bounds of the spiral cam slot 108b (e.g., a zero angle setting, first setting, second setting, third setting, or fourth setting, any setting between the zero angle setting, first setting, second setting, third setting, or fourth setting, or beyond the fourth setting) and to unlock the spiral cam 108 relative to the housing 112 for continuous or in other words, infinite adjustment of the spiral cam 108 between the settings (e.g., between the zero angle setting and the first setting). In the illustrated embodiment, the spiral cam clamps 108d are tightened in an axial direction parallel to the rotary axis RA, and when tightened, provide force to resist rotation of the spiral cam 108.

The front plate 112e further includes a pair of hooks 112h and a window 112i. The hooks 112h are configured to interact with columns 108c of the spiral cam 108 to inhibit undesired over-rotation of the spiral cam 108. The spiral cam 108 further includes a plurality of indicators 108e which, upon rotation of the spiral cam 108, are configured to align with the window 112i in the front plate 112e to indicate to a user or adjuster of the actuator 100 which setting the actuator 100 is configured to function in. The window 112i may be replaced with any indicator portion on the housing 112 so long as a position of one indicator 108e (e.g., a first indicator, “0”) adjacent the indicator portion (window 112i) indicates that the spiral cam 108 is in the first setting, and a position of another indicator 108e (e.g., a second indicator, “1”) adjacent the indicator portion (window 112i) indicates that the spiral cam 108 is in the second setting.

FIGS. 3A and 5A illustrate the spiral cam 108 in a zero (i.e., first) angle setting where the spiral cam pins 108a engage the body 220a of the second support 220 with the contact rollers 220c thereof generally aligned with the first supports 208 (i.e., the fasteners 212). In this arrangement, no distance (i.e., zero distance, a0) along the cantilever axis CA separates the first support 208 and the second support 220. In this position, as illustrated in FIG. 3A, the indicator 108c labeled “0” aligns with the window 112i.

Upon clockwise rotation of the spiral cam 108 from the zero angle, the spiral cam 108 is rotated to a second angle setting (FIGS. 3B and 5B) in which the spiral cam pins 108a are forced by the spiral cam slots 108b to translate the body 220a such that a contact point CP1 between the contact rollers 220c and the cantilever beam 204 is at a distance a1 from the first support 208. Three instances of the second support 220 in this translated position are illustrated as the second support 220′ in FIG. 5B. Further clockwise rotation of the spiral cam 108 results in the contact rollers 220c being positioned at different distances (e.g., a2) relative to the first support 208. For simplicity, one instance of the second support 220 in this further translated position is illustrated as the second support 220″ in FIG. 5B. In this position, a contact point CP2 between the contact rollers 220c and the cantilever beam 204 is at a distance a2 from the first support 208. Due to the continuity of the spiral cam slot 108b, the spiral cam 108 is continuously rotatable between the first angle setting and the second angle setting. As such, the actuator 100 is capable of being configured with any desired position of the spiral cam 108 relative to the housing 112—even desired positions between the first angle setting and the second angle setting. This affords the actuator 100 to be effectively infinite in its adjustability between bounds of movement of the second support 220 within the cantilever receptacle 112g and thus a wide variety of stiffness profiles.

The illustrated embodiment includes indicators 108e corresponding with five (each of 0, 1, 2, 3, and 4) angles of the spiral cam 108. In the illustrated embodiment, an angle of the spiral cam 108 at each position is 0 degrees, 60 degrees, 71 degrees, 78 degrees, and 83.2 degrees. As the spiral cam slot 108b is continuous, an infinite number of other possible orientations of the spiral cam 108 and thus an infinite number of other spiral cam angles, at least between 0 degrees and 83.2 degrees, are possible. Any number of indicators 108e (e.g., fewer than five indicators, five indicators, more than five indicators) may be provided to indicate desired or commonly used angles of the spiral cam 108.

As illustrated in FIGS. 12A, 12B, and 13, rotation of the spiral cam 108 and thus adjusting the distance a0, a1, a2 between the first support 208 and the second support 220 of the cantilever subassembly 200 changes an effective stiffness of the actuator 100 in both plantarflexion and dorsiflexion directions. The spiral cam 108 is rotatable about the rotary axis RA between a first setting (e.g., 0 degree spiral cam angle, indicator 0) and a second setting (e.g., 60 degree spiral cam angle, indicator 1) such that the spiral cam pin 108a is capable of adjusting the distance (a0 to a1). In the first setting (e.g., 0 degree spiral cam angle, indicator 0), the second support 220 (more specifically, the contact roller 220c thereof) is a first distance (a0) from the first support 208, and the actuator 100 exhibits a first stiffness profile (0 deg line, FIGS. 12A, 12B). In the second setting (e.g., 60 degree spiral cam angle, indicator 1), the second support 220 (more specifically, the contact roller 220c thereof) is a second distance (a1) from the first support 208, the second distance a1 is different than the first distance a0, and the actuator 100 exhibits a second stiffness profile (60 deg line, FIGS. 12A, 12B) different than the first stiffness profile.

As noted in the stiffness ratio column of FIG. 13, in each of the envisioned settings of the actuator 100, actual stiffness of the actuator 100 in the plantarflexion direction is between 4 times and 7 times greater than actual stiffness of the actuator 100 in the dorsiflexion direction. Stiffness of the actuator 100 in a first rotational direction of the main cam 104 about the rotary axis RA is at least three time greater than stiffness of the actuator 100 in an opposite second rotational direction of the main cam 104.

The clauses below describe aspects of the actuator 100.
Clause 1. A variable stiffness actuator assembly configured for use in a prosthetic device, the variable stiffness actuator assembly comprising: a main cam including a main cam surface, the main cam configured for rotation about a rotary axis; a connecting pin coupled to the main cam for movement therewith, the connecting pin being configured to be coupled to a first element of the prosthetic device; a spiral cam defining a spiral cam slot; a housing within which the main cam is positioned, the housing including a housing connector configured to be coupled to a second element of the prosthetic device; a cantilever subassembly including a cantilever beam having a first end and an opposite second end, a first support adjacent first end of cantilever beam, the first support being coupled to the housing, a roller adjacent the second end of cantilever beam, the roller in contact with the main cam surface such that the cantilever beam opposes rotation of the main cam, and a second support spaced a distance from the first support, and a spiral cam pin positioned at least partially within the spiral cam slot for movement along the spiral cam slot upon rotation of the spiral cam, the spiral cam pin being coupled to the second support such that rotation of the spiral cam causes movement of the second support, wherein the spiral cam is rotatable about the rotary axis between a first setting and a second setting such that the spiral cam pin is configured to adjust the distance, wherein in the first setting, the second support is a first distance from the first support and the variable stiffness actuator assembly exhibits a first stiffness profile; and wherein in the second setting, the second support is a second distance from the first support, the second distance being different from the first distance, and the variable stiffness actuator assembly exhibits a second stiffness profile different from the first stiffness profile.
Clause 2. The actuator assembly of clause 1, wherein the cantilever beam is configured to be loaded and unloaded upon rotation of the main cam to provide torque between the first element and the second element of the prosthetic device.
Clause 3. The actuator assembly of clause 1, further comprising a spiral cam clamp configured to selectively lock the spiral cam relative to the housing in the first setting or the second setting and to unlock the spiral cam relative to the housing for adjustment of the spiral cam between the first setting and the second setting.
Clause 4. The actuator assembly of clause 1, wherein the housing includes an indicator portion and the spiral cam includes a first indicator and a second indicator, wherein a position of the first indicator adjacent the indicator portion indicates that the spiral cam is in the first setting and a position of the second indicator adjacent the indicator portion indicates that the spiral cam is in the second setting.
Clause 5. The actuator assembly of clause 1, wherein the spiral cam includes at least two spiral cam slots each receiving a corresponding spiral cam pin configured to cause simultaneous movement of a corresponding second support of a corresponding cantilever subassembly upon rotation of the spiral cam.
Clause 6. The actuator assembly of clause 5, wherein each of the first cantilever subassembly and the corresponding cantilever subassemblies are evenly circumferentially spaced about the rotary axis.
Clause 7. The actuator assembly of clause 1, wherein the spiral cam includes at least three spiral cam slots each receiving a corresponding spiral cam pin configured to cause simultaneous movement of a corresponding second support of a corresponding cantilever subassembly upon rotation of the spiral cam.
Clause 8. The actuator assembly of clause 1, wherein the first support is pinned or fixed and the second support is a moving rolling support or a movable fixed support.
Clause 9. The actuator assembly of clause 1, wherein the main cam surface is curved such that, with the spiral cam in the same setting, the main cam is capable of rotation in a plantarflexion direction in which the actuator assembly exhibits a plantarflexion stiffness and an opposite dorsiflexion direction in which the actuator assembly exhibits a dorsiflexion stiffness different to the plantarflexion stiffness.
Clause 10. The actuator assembly of clause 1, wherein when the spiral cam is in the first setting and upon rotation of the main cam in a plantarflexion direction about the rotary axis, stiffness of the actuator assembly is at least 3.5 Newton-meters per radian, and wherein when the spiral cam is in the second setting and upon rotation of the main cam in the plantarflexion direction about the rotary axis, the stiffness of the actuator assembly is at most 12.7 Newton-meters per radian.
Clause 11. The actuator assembly of clause 1, wherein when in the first setting and upon rotation of the main cam in a dorsiflexion direction about the rotary axis, stiffness of the actuator assembly is at least 18.8 Newton-meters per radian and wherein when in the second setting, and upon rotation of the main cam in the dorsiflexion direction about the rotary axis, stiffness of the actuator assembly is at most 77.4 Newton-meters per radian.
Clause 12. A variable stiffness actuator comprising: a main cam including a main cam surface, the main cam configured for rotation about a rotary axis, a cantilever subassembly including a cantilever beam and a roller at a free end thereof, the roller being in contact with the main cam such that the cantilever subassembly opposes rotation of the main cam, wherein the main cam surface and the roller together define a cam follower trajectory curve which includes at least a first segment and a second segment separated by a theoretical equilibrium, the first segment and the second segment being different in curvature, wherein when the roller contacts the main cam surface at a first position corresponding with the first segment, the cantilever beam functions with a first stiffness, and wherein when the roller contacts the main cam surface at a second position corresponding with the second segment, the cantilever beam functions with a second stiffness different than the first stiffness.
Clause 13. The actuator of clause 12, wherein the main cam surface is curved such that stiffness of the actuator in a first rotational direction of the main cam about the rotary axis is at least three times greater than stiffness of the actuator in an opposite second rotational direction of the main cam.
Clause 14. The actuator of clause 12, wherein the main cam surface is curved such that the cam follower trajectory further includes a third segment connected to the first segment, the third segment being curved differently to the first segment such that the actuator is operable in a range from a maximum plantarflexion end of the second segment to a dorsiflexion end of the third segment.
Clause 15. The actuator of clause 12, wherein the main cam is a first main cam having a first main cam surface, and the first main cam removable from the roller, the actuator being configured to receive a second main cam having a second main cam surface having different curvature to the first main cam surface.
Clause 16. The actuator of clause 12, wherein the main cam is statically biased such that a static equilibrium of the actuator differs from the theoretical equilibrium.
Clause 17. A variable stiffness actuator comprising: a main cam including a main cam surface, the main cam configured for rotation about a rotary axis, a cantilever subassembly including a support, and a spiral cam including a spiral cam slot curved about the rotary axis in a spiral cam trajectory, a spiral cam pin positioned at least partially within the spiral cam slot for movement along the spiral cam slot upon rotation of the spiral cam, the spiral cam pin being coupled to the support such that rotation of the spiral cam causes translation of the support along a cantilever axis transverse to the rotary axis, wherein the spiral cam trajectory is curved such than a pressure angle between the cantilever axis and a tangent line extending through the spiral cam slot at a contact point between the spiral cam pin and the spiral cam slot is maintained throughout a range of motion of the spiral cam pin in the spiral cam slot.
Clause 18. The actuator of clause 17, wherein the spiral cam trajectory follows a non-Archimedean spiral.
Clause 19. The actuator of clause 17, wherein the spiral cam trajectory follows a third order polynomial equation.
Clause 20. The actuator of clause 17, further comprising a housing within which the main cam is positioned, and a spiral cam clamp configured to selectively lock the spiral cam relative to the housing in a first setting or a second setting and to unlock the spiral cam relative to the housing for adjustment of the spiral cam between the first setting and the second setting.

Additional information can be found in the following attached manuscript, which is incorporated herein by reference:
“Design and Validation of a Variable Stiffness Spiral Cam Actuator (VS-SCA)”

What is claimed is:

1. A variable stiffness actuator assembly configured for use in a prosthetic device, the variable stiffness actuator assembly comprising:
a main cam including a main cam surface, the main cam configured for rotation about a rotary axis;
a connecting pin coupled to the main cam for movement therewith, the connecting pin being configured to be coupled to a first element of the prosthetic device;
a spiral cam defining a spiral cam slot;
a housing within which the main cam is positioned, the housing including a housing connector configured to be coupled to a second element of the prosthetic device;
a cantilever subassembly including
a cantilever beam having a first end and an opposite second end,
a first support adjacent first end of cantilever beam, the first support being coupled to the housing,
a roller adjacent the second end of cantilever beam, the roller in contact with the main cam surface such that the cantilever beam opposes rotation of the main cam, and
a second support spaced a distance from the first support, and
a spiral cam pin positioned at least partially within the spiral cam slot for movement along the spiral cam slot upon rotation of the spiral cam, the spiral cam pin being coupled to the second support such that rotation of the spiral cam causes movement of the second support,
wherein the spiral cam is rotatable about the rotary axis between a first setting and a second setting such that the spiral cam pin is configured to adjust the distance,
wherein in the first setting, the second support is a first distance from the first support and the variable stiffness actuator assembly exhibits a first stiffness profile; and
wherein in the second setting, the second support is a second distance from the first support, the second distance being different from the first distance, and the variable stiffness actuator assembly exhibits a second stiffness profile different from the first stiffness profile.

2. The actuator assembly of claim 1, wherein the cantilever beam is configured to be loaded and unloaded upon rotation of the main cam to provide torque between the first element and the second element of the prosthetic device.

3. The actuator assembly of claim 1, further comprising a spiral cam clamp configured to selectively lock the spiral cam relative to the housing in the first setting or the second setting and to unlock the spiral cam relative to the housing for adjustment of the spiral cam between the first setting and the second setting.

4. The actuator assembly of claim 1, wherein the housing includes an indicator portion and the spiral cam includes a first indicator and a second indicator, wherein a position of the first indicator adjacent the indicator portion indicates that the spiral cam is in the first setting and a position of the second indicator adjacent the indicator portion indicates that the spiral cam is in the second setting.

5. The actuator assembly of claim 1, wherein the spiral cam includes at least two spiral cam slots each receiving a corresponding spiral cam pin configured to cause simultaneous movement of a corresponding second support of a corresponding cantilever subassembly upon rotation of the spiral cam.

6. The actuator assembly of claim 5, wherein each of the first cantilever subassembly and the corresponding cantilever subassemblies are evenly circumferentially spaced about the rotary axis.

7. The actuator assembly of claim 1, wherein the spiral cam includes at least three spiral cam slots each receiving a corresponding spiral cam pin configured to cause simultaneous movement of a corresponding second support of a corresponding cantilever subassembly upon rotation of the spiral cam.

8. The actuator assembly of claim 1, wherein the first support is pinned or fixed and the second support is a moving rolling support or a movable fixed support.

9. The actuator assembly of claim 1, wherein the main cam surface is curved such that, with the spiral cam in the same setting, the main cam is capable of rotation in a plantarflexion direction in which the actuator assembly exhibits a plantarflexion stiffness and an opposite dorsiflexion direction in which the actuator assembly exhibits a dorsiflexion stiffness different to the plantarflexion stiffness.

10. The actuator assembly of claim 1,
wherein when the spiral cam is in the first setting and upon rotation of the main cam in a plantarflexion direction about the rotary axis, stiffness of the actuator assembly is at least 3.5 Newton-meters per radian, and
wherein when the spiral cam is in the second setting and upon rotation of the main cam in the plantarflexion direction about the rotary axis, the stiffness of the actuator assembly is at most 12.7 Newton-meters per radian.

11. The actuator assembly of claim 1,
wherein when in the first setting and upon rotation of the main cam in a dorsiflexion direction about the rotary axis, stiffness of the actuator assembly is at least 18.8 Newton-meters per radian, and
wherein when in the second setting and upon rotation of the main cam in the dorsiflexion direction about the rotary axis, stiffness of the actuator assembly is at most 77.4 Newton-meters per radian.

12. A variable stiffness actuator comprising:
a main cam including a main cam surface, the main cam configured for rotation about a rotary axis,
a cantilever subassembly including a cantilever beam and a roller at a free end thereof, the roller being in contact with the main cam such that the cantilever subassembly opposes rotation of the main cam,
wherein the main cam surface and the roller together define a cam follower trajectory curve which includes at least a first segment and a second segment separated by a theoretical equilibrium, the first segment and the second segment being different in curvature, wherein when the roller contacts the main cam surface at a first position corresponding with the first segment, the cantilever beam functions with a first stiffness, and
wherein when the roller contacts the main cam surface at a second position corresponding with the second segment, the cantilever beam functions with a second stiffness different than the first stiffness.

13. The actuator of claim 12, wherein the main cam surface is curved such that stiffness of the actuator in a first rotational direction of the main cam about the rotary axis is at least three times greater than stiffness of the actuator in an opposite second rotational direction of the main cam.

14. The actuator of claim 12, wherein the main cam surface is curved such that the cam follower trajectory further includes a third segment connected to the first segment, the third segment being curved differently to the first segment such that the actuator is operable in a range from a maximum plantarflexion end of the second segment to a dorsiflexion end of the third segment.

15. The actuator of claim 12, wherein the main cam is a first main cam having a first main cam surface, and the first main cam removable from the roller, the actuator being configured to receive a second main cam having a second main cam surface having different curvature to the first main cam surface.

16. The actuator of claim 12, wherein the main cam is statically biased such that a static equilibrium of the actuator differs from the theoretical equilibrium.

17. A variable stiffness actuator comprising:
a main cam including a main cam surface, the main cam configured for rotation about a rotary axis,
a cantilever subassembly including a support, and
a spiral cam including
a spiral cam slot curved about the rotary axis in a spiral cam trajectory,
a spiral cam pin positioned at least partially within the spiral cam slot for movement along the spiral cam slot upon rotation of the spiral cam, the spiral cam pin being coupled to the support such that rotation of the spiral cam causes translation of the support along a cantilever axis transverse to the rotary axis,
wherein the spiral cam trajectory is curved such than a pressure angle between the cantilever axis and a tangent line extending through the spiral cam slot at a contact point between the spiral cam pin and the spiral cam slot is maintained throughout a range of motion of the spiral cam pin in the spiral cam slot.

18. The actuator of claim 17, wherein the spiral cam trajectory follows a non-Archimedean spiral.

19. The actuator of claim 17, wherein the spiral cam trajectory follows a third order polynomial equation.

20. The actuator of claim 17, further comprising
a housing within which the main cam is positioned, and
a spiral cam clamp configured to selectively lock the spiral cam relative to the housing in a first setting or a second setting and to unlock the spiral cam relative to the housing for adjustment of the spiral cam between the first setting and the second setting.
